(19) United States
(12) Patent Application Publication
(10) Pub. No.: US 2026/0194429 A1
(43) Pub. Date: Jul. 9, 2026

(54) REGOLITH CONVEYING AND HEATING EXTRACTION APPARATUS

(71) Applicant: Hefei Institutes Of Physical Science, CAS, Hefei (CN)

(72) Inventors: Ruifeng KAN, Hefei (CN); Nailiang CAO, Hefei (CN); Chi ZHANG, Hefei (CN); Zhenyu XU, Hefei (CN); Kan CHEN, Hefei (CN); Jun RUAN, Hefei (CN); Lu YAO, Hefei (CN); Ronghan HU, Hefei (CN); Xiang LI, Hefei (CN); Xingping WANG, Hefei (CN); Wei SHEN, Hefei (CN); Xueli FAN, Hefei (CN); Zhenping SUI, Hefei (CN); Wenzhen LU, Hefei (CN)

(73) Assignee: Hefei Institutes Of Physical Science, CAS, Hefei (CN)

(21) Appl. No.: 19/560,882

(22) Filed: Mar. 9, 2026

Related U.S. Application Data
(63) Continuation of application No. PCT/CN2025/112328, filed on Aug. 4, 2025.

(30) Foreign Application Priority Data
Nov. 6, 2024 (CN) 202411576203.5

(51) Int. Cl. G01N 1/44; G01N 1/00

(52) U.S. Cl. CPC G01N 1/44; G01N 2001/002

(57) ABSTRACT

A regolith conveying and heating extraction apparatus includes a sealing drive module, a station conversion module, and a frame module. The frame module includes a frame, a furnace, and a hopper. The station conversion module includes a station conversion driving assembly, a U-shaped bracket assembly, and a sample assembly. The sample assembly includes a sample holder, a sample tray connected to the sample holder, and an end face sealing assembly. A heating plate and a temperature sensor are integrated on the sample tray. The sample tray moves horizontally in the frame, and has a sample receiving station at a right end, a sealing station at a left end, and a rotation station in a middle. The sample tray extends into the furnace and the end face sealing assembly is in seal fit with the furnace when the sample tray is in the sealing station.

### CROSS-REFERENCE TO RELATED APPLICATION

This patent application is a continuation of International Patent Application No. PCT/CN2025/112328, filed on Aug. 4, 2025, which claims priority of Chinese Patent Application No. 202411576203.5, filed on Nov. 6, 2024.

### TECHNICAL FIELD

The present disclosure relates to the technical field of deep-space resource exploration, in particular to a regolith conveying and heating extraction apparatus.

### BACKGROUND

Exploration of celestial bodies beyond Earth is an eternal mission for humanity. Understanding composition of planetary substances in the universe contributes to understanding the evolution of the earth, and even provides data support for planetary resource exploitation in the future. Therefore, a high-efficiency and high-quality conveying and heating apparatus is a key to analyzing volatile components of regolith. Repeated regolith heating is necessary support for detecting components of volcanic soil.

### SUMMARY

An objective of the present disclosure is to provide a regolith conveying and heating extraction apparatus, configured to collect regolith excavated by a planetary vehicle, and heat regolith by using a heating furnace, so as to release volatile components of regolith.

In order to achieve the foregoing objective, the present disclosure provides the following solution. The present disclosure provides a regolith conveying and heating extraction apparatus, including a sealing drive module, a station conversion module, and a frame module; where
the frame module includes a frame, a furnace, and a hopper, the furnace is cylindrical and is horizontally arranged in the frame and close to a left end face of the frame, an end of the furnace is connected to an external pipeline, and an other end of the furnace has an opening for receiving a sample tray;
the station conversion module includes a station conversion driving assembly, a U-shaped bracket assembly, and a sample assembly, where the U-shaped bracket assembly is horizontally and slidably supported in the frame and driven by the sealing drive module, and the sample assembly is pivotally connected to the U-shaped bracket assembly and is able to be pivoted around a vertical axis, and is driven by the station conversion driving assembly;
the sample assembly includes a sample holder, the sample tray connected to the sample holder, and an end face sealing assembly, where a heating plate and a temperature sensor are integrated on the sample tray;
the sample tray moves horizontally in the frame, and has a sample receiving station at a right end, a sealing station at a left end, and a rotation station in a middle, the sample tray is located directly below the hopper when in the sample receiving station, and the sample tray extends into the furnace as well as the end face sealing assembly is in seal fit with the furnace when the sample tray is in the sealing station; and
in the sealing station, the heating plate in the sample tray heats a sample based on a specified control condition, and volatile components in the sample are conveyed to a detection device through the external pipeline.

In an implementation, the sample tray is in a horizontal rightward orientation when in the sample receiving station, the sample tray rotates to a horizontal leftward orientation from the horizontal rightward orientation when in the rotation station, and the opening of the furnace is horizontally oriented rightward.

In an implementation, the sample tray includes two or more sample trays that are uniformly distributed around a circumferential direction of the sample holder on the sample assembly to work alternately.

In an implementation, the sample tray is rotatably connected to the sample holder around a horizontal axis, and the sample tray is able to be horizontally overturned by 180° to discard the sample.

In an implementation, the apparatus further includes a stress sensor configured to monitor thrust exerted on the furnace.

In an implementation, the sealing drive module includes a sealing motor, a machine base, a turbine worm transmission mechanism and a sealing lead screw, and the sealing motor transmits power to the sealing lead screw at a reduced speed through the turbine worm transmission mechanism.

In an implementation, the apparatus further includes a scraper plate arranged inside the frame, where the scraper plate is configured to shape the sample in the sample tray.

In an implementation, the sample assembly further includes a gear coaxially arranged with the sample tray and a volute spring assembly for rotational resetting of the sample tray, and a discarding method for the sample tray is as follows:
S1: in the rotation station, the sample tray rotates around the vertical axis and projects from a side of a bracket;
S2: the sealing drive module drives the sample tray to move toward the sealing station, and during this process, the gear is meshed with a rack hoisted on the frame to overturn the sample tray by 180°, and then the sample is discarded;
S3: the sealing drive module drives the sample tray to move toward the rotation station, and when the gear is disengaged from engagement with the rack, the sample tray is elastically reset by the volute spring assembly; and
S4: after reaching the rotation station, the sample tray rotates to an idle position for cooling.

Compared with the prior art, embodiments of the present disclosure achieve the following technical effects.

The present disclosure implements functions of sampling, conveying, and heating extraction of regolith, and also has a sample discarding function. The apparatus is reasonable and compact in structure, and can work continuously without stopping.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and those skilled in the art may still derive other accompanying drawings from these accompanying drawings without creative efforts.

FIG. 1 shows a structure of a regolith conveying and heating extraction apparatus in the present disclosure.

FIG. 2 shows a structure of a sealing drive module of the regolith conveying and heating extraction apparatus in the present disclosure.

FIG. 3 shows a structure of a station conversion module of the regolith conveying and heating extraction apparatus in the present disclosure.

FIG. 4 shows a structure of a station conversion driving assembly of the regolith conveying and heating extraction apparatus in the present disclosure.

FIG. 5 shows a structure of a U-shaped bracket assembly of the regolith conveying and heating extraction apparatus in the present disclosure.

FIG. 6 shows a structure of a U-shaped bracket assembly of the regolith conveying and heating extraction apparatus in the present disclosure.

FIG. 7 shows a structure of a sample assembly of the regolith conveying and heating extraction apparatus in the present disclosure.

FIG. 8 is a cross-sectional view taken along line A-A in FIG. 7.

FIG. 9 is a front view of a framework module.

FIG. 10 is a perspective view of the framework module.

FIG. 11 is a side view of the framework module.

FIG. 12 is a perspective view of the framework module.

FIG. 13 is a schematic diagram of the regolith conveying and heating extraction apparatus when the station conversion module is in a rotation station.

FIG. 14 is a schematic diagram of the regolith conveying and heating extraction apparatus when the station conversion module is in a sample receiving station.

FIG. 15 is a schematic diagram of the regolith conveying and heating extraction apparatus when the station conversion module is in a sealing station.

FIG. 16 is a schematic diagram of the regolith conveying and heating extraction apparatus when the station conversion module is in a sample discarding station.

FIG. 17 shows the rotating state of the sample tray.

FIG. 18 shows the complete sample discarding state of the sample tray.

### DETAILED DESCRIPTION OF THE EMBODIMENTS

The following clearly and completely describes technical solutions in embodiments of the present disclosure with reference to drawings in the embodiments of the present disclosure. Apparently, the described embodiments are merely a part rather than all of the embodiments of the present disclosure. All other embodiments obtained by those skilled in the art on the basis of the embodiments of the present disclosure without requiring the exercise of inventive effort fall within the scope of protection of the present disclosure.

An objective of the present disclosure is to provide a regolith conveying and heating extraction apparatus, configured to collect regolith excavated by a planetary vehicle, and heat regolith by using a heating furnace, so as to release volatile components of regolith.

To make the foregoing objective, features and advantages of the present disclosure clearer and more comprehensible, the present disclosure is further described in detail below with reference to the drawings and the specific implementations.

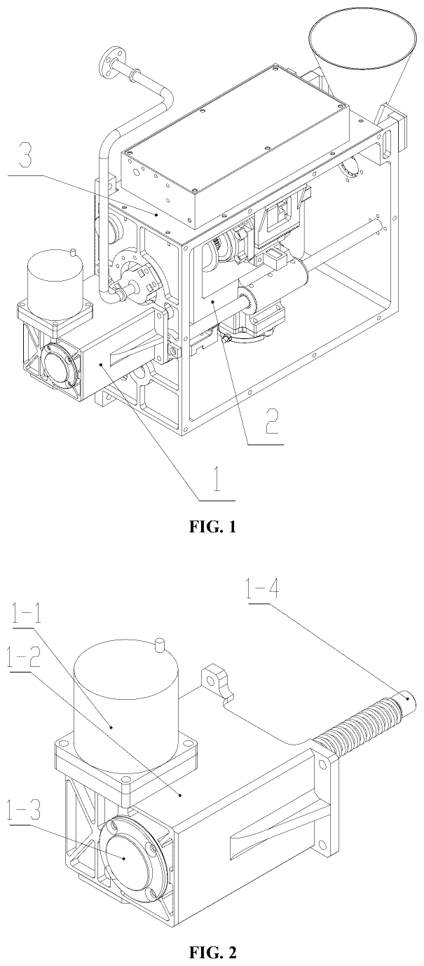

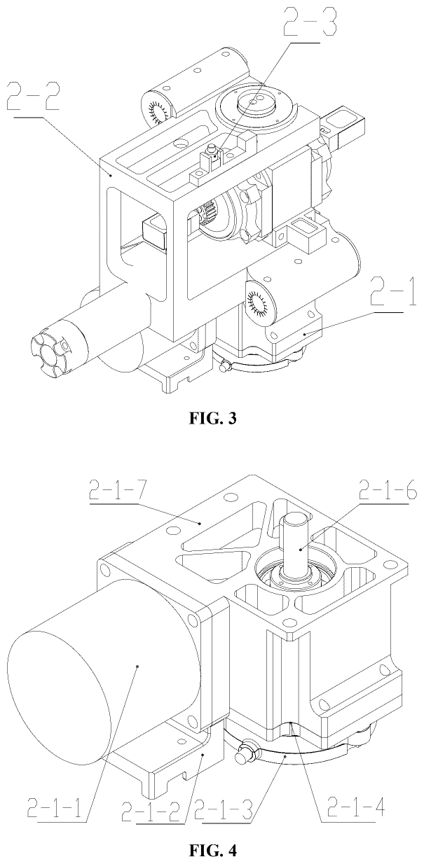

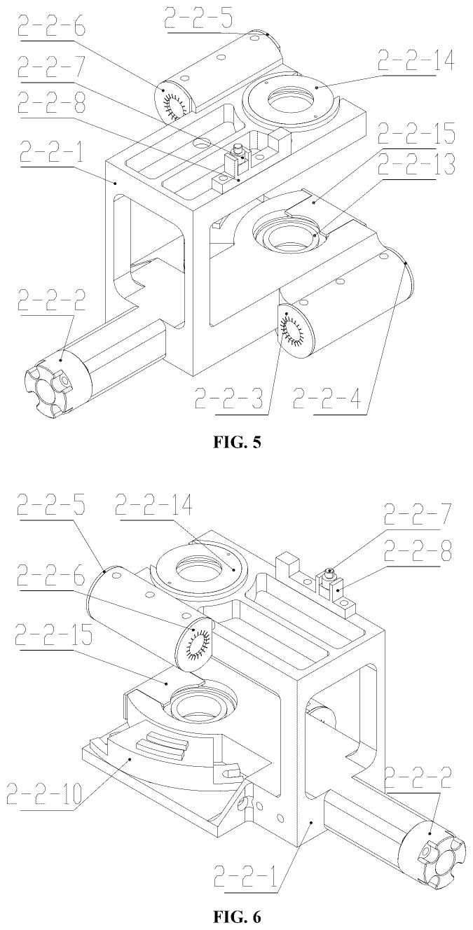

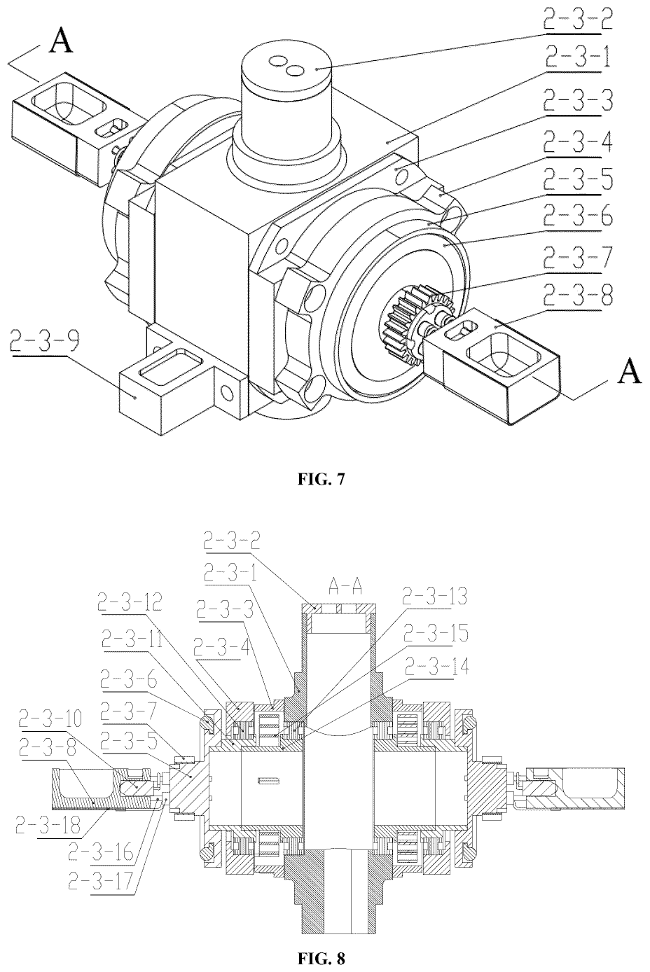

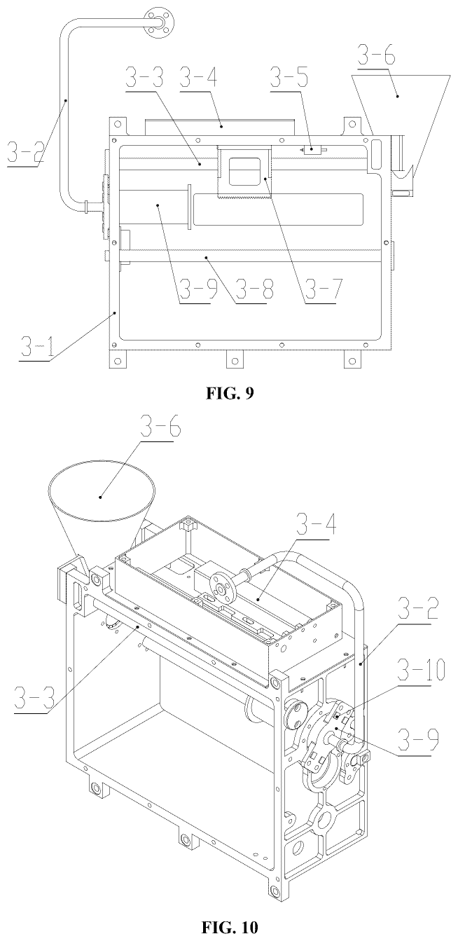

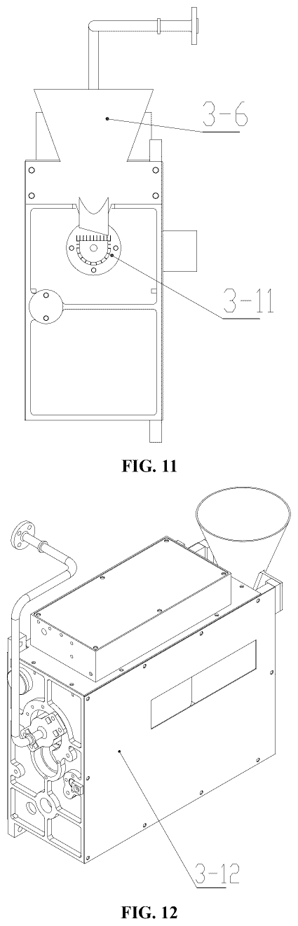

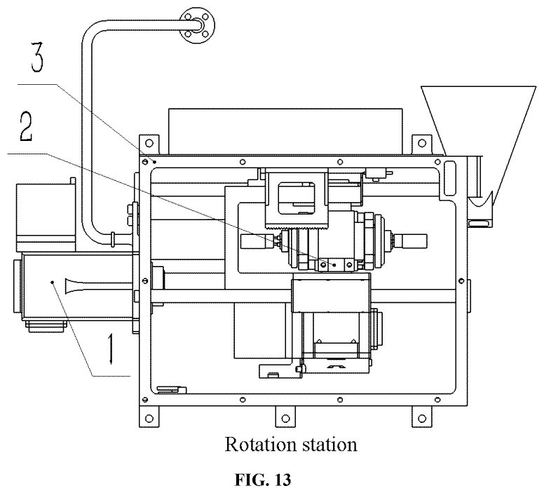

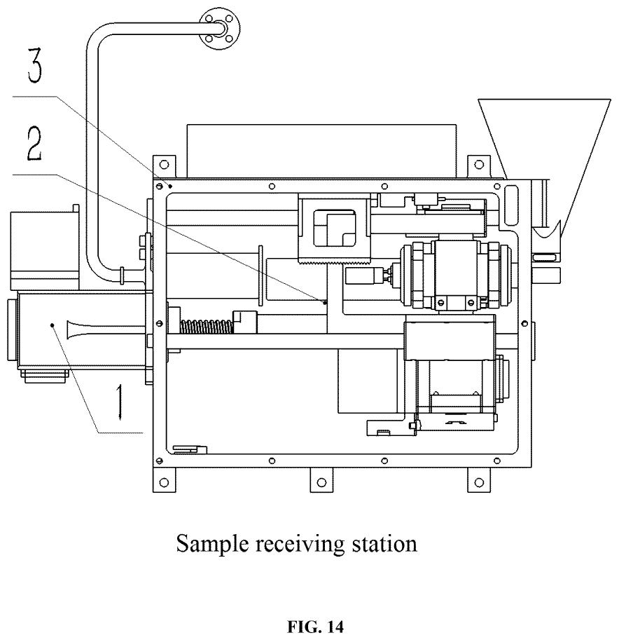

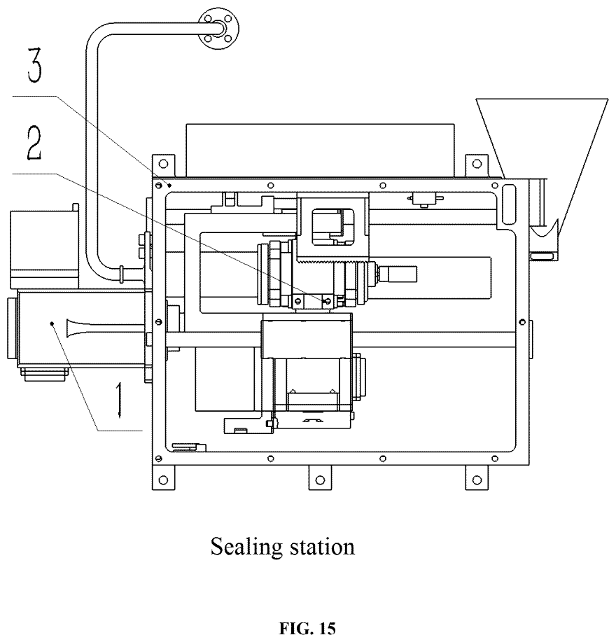

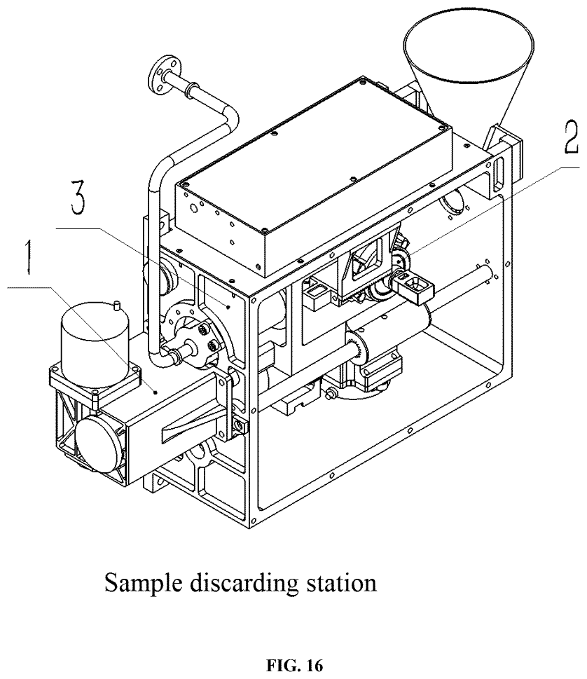

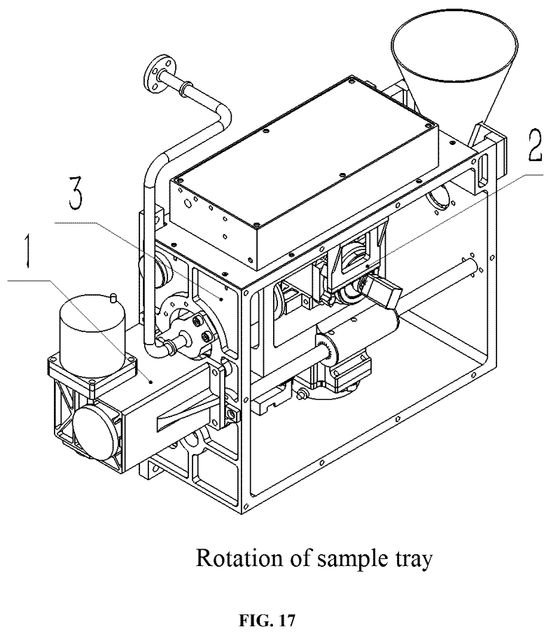

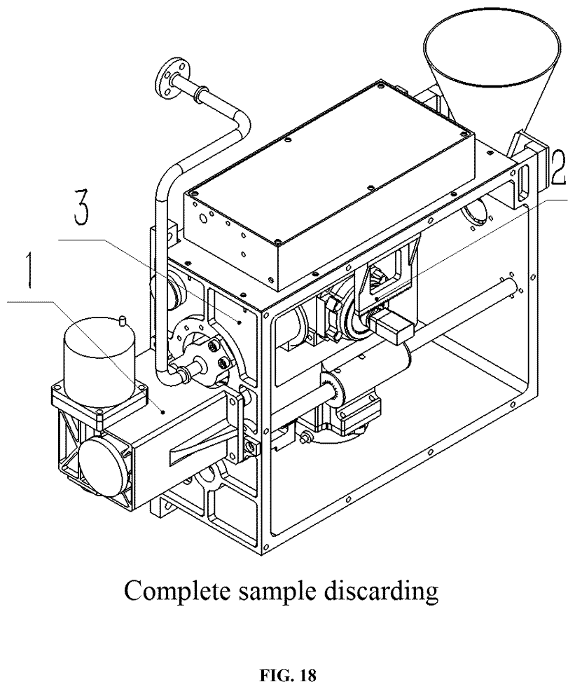

As shown in FIG. 1 to FIG. 18, a regolith conveying and heating extraction apparatus provided in the present disclosure includes three parts: a sealing drive module 1, a station conversion module 2, and a frame module 3.

The sealing drive module 1 drives the station conversion module 2 to move horizontally. The station conversion module 2 is provided with a pair of sample assemblies, so as to implement quantitative collection and conveying of regolith to a furnace assembly and discard a sample. The furnace assembly and an external pipeline on the frame module 3 cooperate with the sample assemblies to implement sample heating extraction, and volatile components are conveyed to an external detection apparatus through the pipeline.

The sealing drive module 1 includes a sealing motor 1-1, a machine base 1-2, a turbine worm transmission mechanism 1-3, and a sealing lead screw 1-4. The sealing motor 1-1 transmits power at a reduced speed through the turbine worm transmission mechanism 1-3, and has a transmission self-locking function. The sealing lead screw 1-4 drives to cooperate with a nut of the station conversion module 2 to form a lead screw nut pair.

The station conversion module 2 includes a station conversion driving assembly 2-1, a U-shaped bracket assembly 2-2, and a sample assembly 2-3, and the station conversion assembly 2-1 and the sample assembly 2-3 are mounted on the U-shaped bracket assembly 2-2.

The station conversion driving assembly 2-1 includes a station conversion motor 2-1-1, a rigid flexible belt fixed seat 2-1-2, an encoder 2-1-3, a turbine worm transmission mechanism 2-1-4, a station conversion shaft 2-1-6, and a fixed seat 2-1-7. The station conversion motor 2-1-1 is fastened to the fixed seat 2-1-7 through screws. When the station conversion motor 2-1-1 rotates, a worm and a turbine in the turbine worm transmission mechanism 2-1-4 can be driven to decelerate for conveying, thereby driving the rotation of the station conversion shaft 2-1-6 that cooperates with the turbine.

The U-shaped bracket assembly 2-2 includes a U-shaped bracket 2-2-1, a trapezoidal nut 2-2-2, a polytetrafluoroethylene scraper cushion A 2-2-3, a polytetrafluoroethylene scraper cushion B 2-2-4, a polytetrafluoroethylene scraper cushion C 2-2-5, a polytetrafluoroethylene scraper cushion D 2-2-6, a linear potentiometer shaft 2-2-7, a linear potentiometer support 2-2-8, a Hall sensor Feb. 2, 2010, a lower bearing Feb. 2, 2013, a gland Feb. 2, 2014, and a dust cover Feb. 2, 2015.

The U-shaped bracket 2-2-1 is provided with a pair of bearings, and the gland Feb. 2, 2014 is arranged on an upper bearing to fasten an outer ring of the bearing. The dust cover Feb. 2, 2015 arranged on the U-shaped bracket 2-2-1 is configured to protect the lower bearing Feb. 2, 2013.

An end of the sample holder 2-3-1 in the sample assembly 2-3 is fitted with the upper bearing, and an other end the sample holder 2-3-1 is fitted with the lower bearing Feb. 2, 2013 to form a rotating mechanism. The station conversion driving assembly 2-1 is mounted on the U-shaped bracket 2-2-1. The station conversion shaft 2-1-6 is connected to the sample holder 2-3-1 by using a key. The station conversion driving assembly 2-1 can drive the sample assembly 2-3 to rotate when rotating.

The sample assembly 2-3 includes a sample holder 2-3-1, a wire fixed seat 2-3-2, volute spring seats 2-3-3, covers 2-3-4, sealing ring seats 2-3-5, sealing rings 2-3-6, gears 2-3-7, sample trays 2-3-8, Hall magnet steel 2-3-9, temperature sensors Feb. 3, 2010, bearing seats A Feb. 3, 2011, bearings A Feb. 3, 2012, bearings B Feb. 3, 2013, volute spring shafts Feb. 3, 2014, volute springs Feb. 3, 2015, needle rods Feb. 3, 2016, rod seats Feb. 3, 2017, and heating plates Feb. 3, 2018.

The sealing ring seat 2-3-5 is glued to the bearing seat A Feb. 3, 2011. The bearing A Feb. 3, 2012 is arranged on the bearing seat A Feb. 3, 2011, the fixed bearing A Feb. 3, 2012 is placed inside the cover 2-3-4, and the cover 2-3-4 is fastened to the volute spring seat 2-3-3 with screws.

The volute spring Feb. 3, 2015 is arranged between the volute spring seat 2-3-3 and the volute spring shaft Feb. 3, 2014. An end of the volute spring Feb. 3, 2015 is fastened to the volute spring shaft Feb. 3, 2014, and an other end of the volute spring Feb. 3, 2015 is fastened to the volute spring seat 2-3-3. The bearing B Feb. 3, 2013 is arranged between the volute spring shaft Feb. 3, 2014 and the sample holder 2-3-1.

The volute spring seat 2-3-3 is fastened to the sample seat 2-3-1. Therefore, the sealing ring seat 2-3-5, the bearing seat A Feb. 3, 2011, the fixed bearing A Feb. 3, 2012, the cover 2-3-4, the volute spring seat 2-3-3, the sample seat 2-3-1, the bearing B Feb. 3, 2013, and the volute spring shaft Feb. 3, 2014 form a rotating system.

The gear 2-3-7 is arranged at an end of the sealing ring seat 2-3-5. The gear 2-3-7 is fastened to the end of the sealing ring seat 2-3-5. Torque is applied to the gear 2-3-7. The sealing ring seat 2-3-5 rotates with the bearing A Feb. 3, 2012 and the bearing B Feb. 3, 2013. After rotation at a specific angle, the volute spring Feb. 3, 2015 will be charged with energy. After the torque applied to the gear 2-3-7 is loosened, the volute spring Feb. 3, 2015 may rebound rapidly, so that the sealing ring seat 2-3-5 rebounds rapidly to an original position.

Four rod seats Feb. 3, 2017 are arranged on the sealing ring seat 2-3-5. Four needle rods Feb. 3, 2016 are arranged on the rod seats Feb. 3, 2017. The rod seats Feb. 3, 2017 are sintered between the sealing ring seat 2-3-5 and the needle rods Feb. 3, 2016. Four needle rods Feb. 3, 2016 are connected to the sample tray 2-3-8. The temperature sensor Feb. 3, 2010 is arranged at a tail of the sample tray 2-3-8 to measure a temperature of the sample tray 2-3-8. The two upper needle rods Feb. 3, 2016 are connected to two wires of the temperature sensor Feb. 3, 2010. The two lower needle rods Feb. 3, 2016 are connected to two wires of the heating plate Feb. 3, 2018 on a surface of the sample tray to heat the sample tray 2-3-8.

The sample tray 2-3-8 is driven to rotate when the sealing ring seat 2-3-5 rotates. In addition, the Hall magnet steel 2-3-9 is arranged on the sample holder 2-3-1 to control a rotation angle of the sample assembly 2-3. The wire fixed seat 2-3-2 is arranged on the sample holder 2-3-1 to fasten the wires drawn from the needle rod Feb. 3, 2016. A right part of the sample assembly 2-3 is completely symmetrical to a left part of the sample assembly 2-3, and the parts used are identical. The frame module 3 includes a frame 3-1, an exhaust pipeline 3-2, a guide rod A 3-3, a linear potentiometer 3-4, a funnel 3-6, a rack 3-7, a guide rod B 3-8, a furnace 3-9, a strain gage 3-10, a scraper plate 3-11, and a cover plate 3-12.

The U-shaped bracket assembly 2-2 is fitted with the guide rod A 3-3 and the guide rod B 3-8 arranged on the frame module 3 through a pair of sliding blocks to form a sliding friction pair. In addition, the polytetrafluoroethylene scraper cushion A 2-2-3, the polytetrafluoroethylene scraper cushion B 2-2-4, the polytetrafluoroethylene scraper cushion C 2-2-5, and the polytetrafluoroethylene scraper cushion D 2-2-6 are arranged at both ends of the pair of sliding blocks, so as to protect the pair of sliding blocks and prevent dust from entering the sliding friction pair.

The sealing drive module 1 is mounted on the U-shaped bracket 2-2-1 of the frame module 3. The sealing lead screw 1-5 on the sealing drive module 1 is fitted with the trapezoidal nut 2-2-2 to form a screw pair. When the sealing lead screw 1-4 of the sealing drive module 1 rotates, the trapezoidal nut 2-2-2 is driven to move, thereby driving the station conversion module 2 to move. The linear potentiometer 3-4 cooperates with the linear potentiometer shaft 2-2-7 to monitor a moving distance of the station conversion module 2 in real time.

When the station conversion module 2 is in a rotation station, rotation of the sealing drive module 1 drives the station conversion module 2 to move toward a sample receiving station. When the linear potentiometer 3-4 detects that the station conversion module 2 has reached the sample receiving station and a micro switch 3-5 makes contact with the linear potentiometer support 2-2-8, the sealing drive module 1 stops rotating, the station conversion module 2 is in the sample receiving station, and an external device (for example, a robot) sends the sample to the sample tray 2-3-8 through the funnel 3-6.

Then, the sealing drive module 1 rotates reversely, so that the station conversion module 2 moves reversely. When the sample tray 2-3-8 moves to a position in which the scraper plate 3-11 is located, the scraper plate 3-11 may shape the sample in the sample tray 2-3-8, thereby facilitating subsequent heating.

When the linear potentiometer 3-4 arranged on the station conversion module 2 detects that the station conversion module 2 has moved a specified distance, and after the strain gage 3-14 detects that the sealing ring seat 2-3-5 on the station conversion module 2 makes contact with the furnace 3-9 to generate a specified stress, the sealing drive module 1 stops rotating, so that the station conversion module 2 stops moving. In this case, the sample is heated by the sample tray 2-3-8, so that components of the sample are volatilized and conveyed to a detection device through the exhaust pipeline 3-2. Heating duration and temperature are set as required, the heating duration is usually 10 min to 30 min, and the heating temperature does not exceed 300° C.

After heating is completed, the sealing drive module 1 rotates so that the station conversion module 2 moves in a sample receiving direction. When the linear potentiometer 3-4 detects that the station conversion module 2 has reached the rotation station, the sealing drive module 1 stops rotating, so that the station conversion module 2 stops moving. In this case, the station conversion driving assembly 2-1 in the station conversion module 2 starts rotating, so that the sample assembly 2-3 is driven to rotate horizontally. When the encoder 2-1-3 detects that the sample assembly 2-3 rotates to a sample discarding position (rotating by) 90°, the station conversion driving assembly 2-1 stops rotating, so that the sample assembly 2-3 stops rotating.

In this case, the sealing drive module 1 starts to drive the station conversion module 2 to move toward a sealing station. When the gear 2-3-7 on the sample assembly 2-3 moves to the rack 3-7 of the frame module 3 for engagement, because movement of the gear 2-3-7 can drive the sample tray 2-3-8 on the sealing ring seat 2-3-5 to be overturned by 180°, sample discarding is implemented. After sample discarding is completed, the sealing drive module 1 moves in an opposite direction until the station conversion module 2 is in the rotation station again, and one working cycle is ended. The cover plates 3-12 are arranged on both side surfaces and a top surfaces of the frame module, so as to protect the station conversion module 2.

The sample tray on the right side of the sample assembly 2-3 is alternately used with the sample tray on the left side. In this way, when one sample tray is heated, the other sample tray is in a heat dissipation cooling state, so that the sample can be sampled without interruption, and cooling interval time is reduced.

Adaptive changes made according to actual requirements are all within the protection scope of the present disclosure.

It should be noted that, for those skilled in the art, it is apparent that the present disclosure is not limited to the details of the exemplary embodiment, and the present disclosure can be achieved in other specific forms without departing from the spirit or essential characteristics of the present disclosure. Therefore, for every point, the embodiments should be regarded as exemplary embodiments and are unrestrictive, the scope of the present disclosure is restricted by the claims appended hereto, and therefore, all changes, including the meanings and scopes of equivalent elements, of the claims are aimed to be included in the present disclosure. Any mark of accompanying drawings in the claims should not be regarded as limitation to the involved claims.

Specific examples are used for illustration of the principles and implementations of the present disclosure. The description of the above-mentioned embodiments is used to help illustrate the method and core principles of the present disclosure. In addition, those skilled in the art can make various modifications in terms of specific implementations and scope of application in accordance with the teachings of the present disclosure. In summary, the contents of this specification should not be understood as the limitation of the present disclosure.

What is claimed is:

1. A regolith conveying and heating extraction apparatus, comprising a sealing drive module, a station conversion module, and a frame module, wherein
the frame module comprises a frame, a furnace, and a hopper, the furnace is cylindrical and is horizontally arranged in the frame and close to a left end face of the frame, an end of the furnace is connected to an external pipeline, and an other end of the furnace has an opening for receiving a sample tray;
the station conversion module comprises a station conversion driving assembly, a U-shaped bracket assembly, and a sample assembly, wherein the U-shaped bracket assembly is horizontally and slidably supported in the frame and driven by the sealing drive module, and the sample assembly is pivotally connected to the U-shaped bracket assembly and is able to be pivoted around a vertical axis, and is driven by the station conversion driving assembly;
the sample assembly comprises a sample holder, the sample tray connected to the sample holder, and an end face sealing assembly, wherein a heating plate and a temperature sensor are integrated on the sample tray;
the sample tray moves horizontally in the frame, and has a sample receiving station at a right end, a sealing station at a left end, and a rotation station in a middle, the sample tray is located directly below the hopper when in the sample receiving station, and the sample tray extends into the furnace as well as the end face sealing assembly is in seal fit with the furnace when the sample tray is in the sealing station; and
in the sealing station, the heating plate in the sample tray heats a sample based on a specified control condition, and volatile components in the sample are conveyed to a detection device through the external pipeline.

2. The regolith conveying and heating extraction apparatus according to claim 1, wherein the sample tray is in a horizontal rightward orientation when in the sample receiving station, the sample tray rotates to a horizontal leftward orientation from the horizontal rightward orientation when in the rotation station, and the opening of the furnace is horizontally oriented rightward.

3. The regolith conveying and heating extraction apparatus according to claim 1, wherein the sample tray comprises two or more sample trays that are uniformly distributed around a circumferential direction of the sample holder on the sample assembly to work alternately.

4. The regolith conveying and heating extraction apparatus according to claim 1, wherein the sample tray is rotatably connected to the sample holder around a horizontal axis, and the sample tray is able to be horizontally overturned by 180° to discard the sample.

5. The regolith conveying and heating extraction apparatus according to claim 1, further comprising a stress sensor configured to monitor thrust exerted on the furnace.

6. The regolith conveying and heating extraction apparatus according to claim 1, wherein the sealing drive module comprises a sealing motor, a machine base, a turbine worm transmission mechanism and a sealing lead screw, and the sealing motor transmits power to the sealing lead screw at a reduced speed through the turbine worm transmission mechanism.

7. The regolith conveying and heating extraction apparatus according to claim 1, further comprising a scraper plate arranged inside the frame, wherein the scraper plate is configured to shape the sample in the sample tray.

8. The regolith conveying and heating extraction apparatus according to claim 1, wherein the sample assembly further comprises a gear coaxially arranged with the sample tray and a volute spring assembly for rotational resetting of the sample tray, and a discarding method for the sample tray is as follows:
S1: in the rotation station, the sample tray rotates around the vertical axis and projects from a side of a bracket;
S2: the sealing drive module drives the sample tray to move toward the sealing station, and during this process, the gear is meshed with a rack hoisted on the frame to overturn the sample tray by 180°, and then the sample is discarded;
S3: the sealing drive module drives the sample tray to move toward the rotation station, and when the gear is disengaged from engagement with the rack, the sample tray is elastically reset by the volute spring assembly; and
S4: after reaching the rotation station, the sample tray rotates to an idle position for cooling.
